(19) United States
(12) Patent Application Publication
(10) Pub. No.: US 2002/0126659 A1
(43) Pub. Date: Sep. 12, 2002

(54) Unified software architecture for switch connection management

(76) Inventors: Ling-Zhong Liu, Ottawa (CA); Jesse Z. Zhang, Kanata (CA)

Correspondence Address: MARKS & CLERK, P.O. BOX 957, STATION B, OTTAWA, ON, K1P 5S7, CA

(21) Appl. No.: 10/086,866

(22) Filed: Mar. 4, 2002

Related U.S. Application Data
(60) Provisional application No. 60/273,645, filed on Mar. 7, 2001.

(51) Int. Cl. H04L 12/50; H04Q 11/00

(52) U.S. Cl. 370/357

(57) ABSTRACT

A software architecture for managing switch connections in a communications system is described. The management architecture of this invention introduces an abstraction layer that hides hardware specific information from the core switch connection management and higher-level applications. This reduces or eliminates the dependency of the software on the hardware, and enables other applications such as simulation, test and diagnostics, switch fabric maintenance, and performance measurement or management on the same software.

This invention claims the benefit of U.S. Provisional Application No. 60/273,645 filed Mar. 7, 2001.

### FIELD OF THE INVENTION

This invention relates to communications systems and more particularly to an improved software architecture for the management of switch connections in such systems.

### BACKGROUND

It is well known that in communications systems a connection is setup between an originator and a destination in order to complete a communication session. The connection, typically, is routed through intermediate switching nodes that work together to set up the connection for the duration of the call and to tear it down when the call is completed. In such a typical system each switching node processes numerous connections at that same time and effective management of the call processing is critical to the efficient operation of the network.

Numerous problems have been identified in current switching management systems that lead to less than optimum results. One of these problems involves bulk or group switch connections and the inability to make rapid modifications to such connections. Another related problem is the lack of flexibility in replacing or upgrading switch fabric cards. In current switch management systems the switch connection software tends to be dependent on system hardware. This not only limits the adaptability of a system but also reduces scalability in switch connection management.

Accordingly there is room for improvement in the connection management of switches at switching nodes in a communication network.

### SUMMARY OF THE INVENTION

The present invention provides this improvement through the introduction and management of multiple connection tables implemented in the software architecture of a connection manager. The connection manager includes a system abstraction layer that hides specific hardware information relating to the switching card from the upper layer connection management and the higher-level application.

Therefore in accordance with a first broad aspect of the present invention there is provided a method of managing switch connections at a switching node in a communications system, the method comprising: providing connection requests from a higher level application to a connection manager in the switching node; processing the requests in the connection manager to generate a connection table; and based on the connection table, routing the commands from the connection manager to switch card elements in the switching nodes to carry out the requests.

In accordance with a second broad aspect of the invention there is provided a system for managing switch connections at a switching node in a communications network, the system comprising: means for receiving connection specific requests from a higher level application; a connection manager for processing the connection specific requests and generating a connection table which maps external ports to an internal switching matrix for use in routing the requests; and switch card elements for receiving routing information and carrying out connection requests.

### BRIEF DESCRIPTION OF THE DRAWINGS

The invention will now be described in greater detail with reference to the attached drawings wherein;

FIG. 1 illustrates the overall architecture of the unified connection management scheme;

FIG. 2 is an example of the handling of a multi-stage switching card;

FIG. 3 is a diagram of a network and a switching node; and

FIG. 4 shows an active connection table and an inactive connection table for local link protection.

### DETAILED DESCRIPTION OF THE INVENTION

Taking full advantages of some commercially available switch chips that are capable of storing and setting multiple configuration patterns (such as the TZA2080 Asynchronous crosspoint switch chip from Philips Semiconductor), the software architecture of the present invention enables fast modifications of bulk (or group) connections for a virtual or circuit based switched communication system. As will be described later, it is done through the introduction and management of multiple connection tables in the software, which provides the flexibility of fast route or link switchover and recovery.

The generic design and implementation of the switch connection management software provides a unified interface to switch fabric cards that have multiple configuration settings feature, and those that don't, which enables easy upgrade of the switch fabric hardware or replacement. The switching connection management architecture also introduces an abstraction layer which hides hardware specific information from the core switch connection management and higher level applications which, therefore reduces or eliminates the dependency of the software on the hardware, and enables other applications such as simulation, test and diagnostics, switch fabric maintenance, and performance measurement or management on the same software.

The connection table(s) in this architecture are generated with flexibility in format and size, which provides easy adaptation to different switching size requirements (e.g., 64×64, 128×128, or 512×512, etc.), and therefore with the maximum scalability in terms of the switch size.

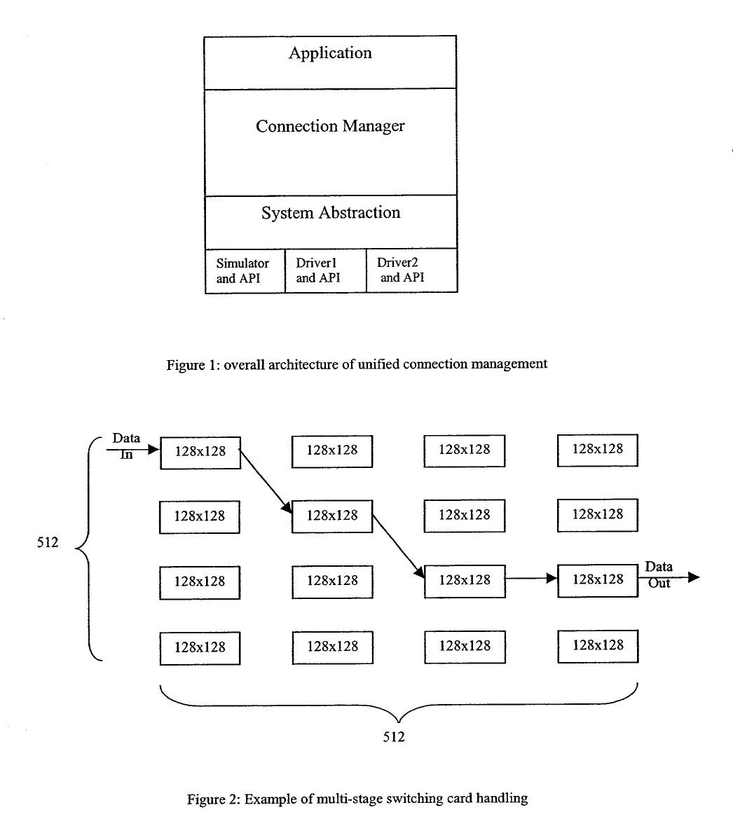

The overall architecture of the present invention is shown in block diagram form in FIG. 1. The architecture consists of the higher level application, the connection manager (including a system abstraction layer), and the switching fabric card specific drivers, simulators and their APIs.

The higher-level application is responsible for issuing the particular requests to the connection manager. Examples of these requests are: connection related commands, which include setup, teardown, modify and inquiry; and configuration related requests, which indicate the configuration of specific switching card types. Maintenance actions such as loopbacks are also part of these requests from the application layer.

The main responsibilities of the connection manger includes: providing the interface to the higher level applications; managing the internal switching matrix table(s), also called connection table(s), which represents the logical connections for the switching node, mapping of the external port numbers (physical) to the internal switching matrix numbers (logical) for making the connection; and issuing the appropriate commands to the switching card/ chip driver(s) for making proper connections.

The system abstraction layer is considered a sub-layer within the connection manager. This sub-layer hides the switching card specific hardware information from the upper layer connection management and the upper layer application. The system abstraction layer enables independent connection management and application software for the lower level hardware—the switching card(s) and chip(s).

Underneath the abstraction layer are the card specific drivers and simulators. Different drivers and simulators handle different kinds of hardware specific commands for loading certain registers in order to make the connection for the switching chips on the switching fabric cards. The Connection Manager initiates Hardware specific switching actions through the APIs provided by these drivers and simulators.

The following description relates to the overall system configuration and provides initialization details.

Once a switch fabric card is inserted in to a circuit or virtual connection based switching node, the node software scans or reads the card type label that is stored in certain registers in the switching fabric card hardware. The card type label provides the card type related information. Information from the card type label is processed by the switching node software and is stored in the database. From this card type information, the switching node knows what kind of switching fabric card it is, whether the card, and the associated chips, supports multiple configuration table settings or not (and how many if it does), whether it is a multi-stage switch fabric or not, the size of the switching matrix, and other information. Using this information, the switching node software constructs a connection manager instance that will handle all the connection related requests from the higher level applications. The above information, derived from the switching fabric card type label, is also stored in the connection manager for easy and fast access and processing later on. When an existing switching fabric card is replaced with a new one of the same type, the node software will construct a new connection manager instance having the same information concerning the switching fabric card. However, if another type of switching fabric card is inserted, and configured, into the node, a new connection manager instance will be constructed with new information corresponding to this particular card type.

The connection manager, in turn, generates connection table(s) according to the card related information in the connection manager instance. The table(s) are two-dimensional array type, with the desired switching fabric matrix size. In the case of handling the switching fabric cards that don't have multiple configuration settings, only one connection table will be generated and this table will be in an active state once the node is properly configured and initialized. However in the case of handling switching fabric cards that do support multiple configuration settings (e.g., four different configuration settings plus one default setting), multiple connection tables will be generated: the number of connection tables corresponding to the number of configuration settings the card can support. The connection table identification (ID) corresponds to the appropriate configuration table in the hardware. All connection tables are empty (i.e., without any connections) at this point. And only one connection table is in an active state, while others are in an inactive state. In the switch hardware, the default configuration setting will be the active one by default.

The connection manager then constructs an abstraction layer manager, which will manage switch fabric cards specific drivers. To the connection manager, the abstraction layer manager can be in a form of API, overloaded (object-oriented term) to handle different switching card types. This driver contains and processes all the card type specific messages or commands, such as mapping of the higher level connection related commands or messages to hardware specific formats, and setting certain configuration tables in the hardware (chips) to make connections with correct input and output ports. Different switch fabric card types will have a different driver, and the abstraction layer manager will construct the appropriate driver instance from the information passed from the connection manager during abstraction layer manager construction. In the case of multi-stage switching fabric cards, the driver must map the higher level switch matrix input and output ports (as in the connection table) to the switch input and output for each switching chip, and send connection commands to all required chips in order to make the correct connection (see FIG. 2 for an example). In the case of a switching fabric card that supports multiple configuration settings, the driver instance is capable of sending an activate command to activate certain configuration settings in the hardware chip, which will be used to make a group of connections (bulk connections) with a single command as described later.

Once the switch node initialization has finished, the connection manager is in an active state which means that it is ready to handle any connection related requests from higher level applications. In this description only the following requests are considered: setup, teardown, modify and inquiry. Modifying a connection is in general performed by two consecutive actions: first to teardown any existing connection, and the second to make the new connection as required. In the case of making a connection, the higher-level application sends a connection command to the connection manager. The command contains the input and output port numbers for which the connection is to be made, as well as other related information, such as protection, etc. The connection manager will then map these higher-level input and output port numbers into the switch matrix (i.e., the connection table) format. If the connection table shows that this connection is valid, then the connection manager will set the corresponding entry (with switch input and output port indices), and send a generalized connection command to the lower abstraction layer. Since the lower abstraction layer contains the card specific driver instance, the specific driver will translate the connection manager's connect command into the hardware specific format and set the appropriate configuration table in the switching chip to make the proper connection. Tearing down an existing connection is performed in a similar fashion, except that in this case the entry in the connection table, where the existing connection is recorded, will be reset rather than set. In the case of connection inquiry, the connection manager simply reads the connection table to see whether some specific connections have been made, or if there is any connection at all.

In FIG. 2, 16 128×128 switch chips are used to achieve a 512×512 non-blocking switching matrix in order to make a connection from any input to any output, as requested by the higher-level applications and the connection manager. The switch card specific driver must have a routing algorithm and send specific connection commands to each 128×128 switching chip in the 512×512 non-blocking array to route a data path through the entire array. See FIG. 2.

If the switch card supports multiple configuration settings, some of the configuration tables can be set in a pre-determined format through a node's configuration and provisioning, or through maintenance action (this is usually the case during hardware maintenance). The predetermined configurations are stored in the corresponding connection tables in the connection manager, and in the configuration tables in the hardware. For example, if a switch card supports five different configuration settings and a default table, then it is possible to have five pre-determined connection tables: maybe, for example, tables 1 and 2 for test and diagnostics of different connections, table 3 for maintenance action (such as traffic measurement), table 4 for performance monitoring, and table 5 for fast link/ trunk/fiber/traffic pipes protection recovery. The default setting (which usually corresponds to the active connection table unless specified by a command explicitly) is for making normal connections. In the case of fast link/trunk/fiber protection recovery, some special handling is needed which is described later. The processing for the other configuration settings is very similar: for example, once the higher level application determines it is time to do a connection test on a certain pattern, this application sends a connection request message to the connection manager, where the connection message contains an action pointer indicating which connection pattern to be used. The connection manager will then send an activate command, including the ID for the connection table to use, to the lower layer. The driver will then send the proper command to the switching chip hardware to activate the appropriate configuration table. Therefore the desired connections are made with a single command with minimum latency

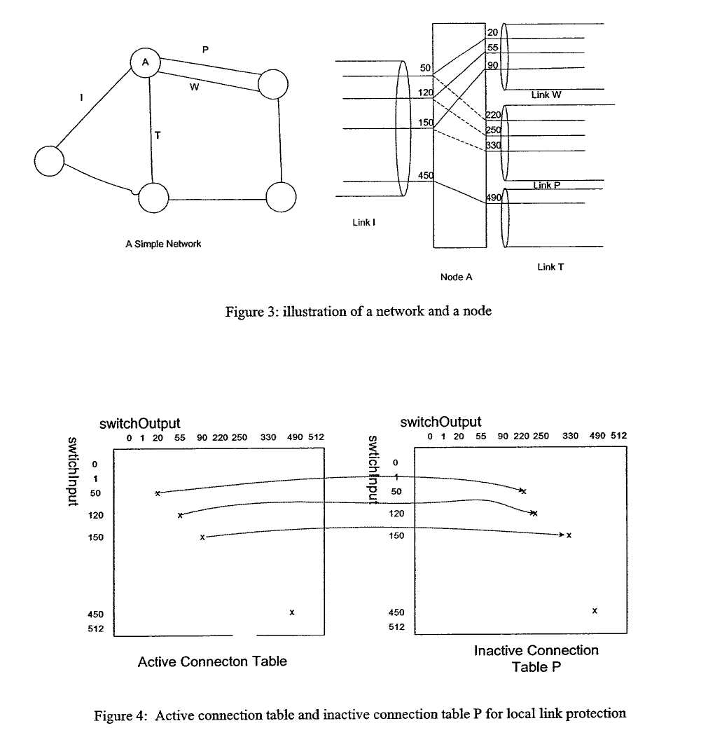

In some scenarios, a network node may decide to have a local protection for a group (or trunk) of connections. Consider a simple network and the local node structure as shown in FIG. 3. Node A has a local link W(or trunk or fiber) that can be protected by link P. In the following examples, Node A is assumed to have a switching card that supports multiple configuration tables, and it is a 512×512 switch matrix.

When the node A configures link W as being protected by link P, the connection manager records that information, and assign an inactive connection table P for this purpose. When the node makes a connection, the application sends a connection request to the connection manager indicating where the connection is to be (the input and output ports), and the protection flag (which indicates whether the connection is the node's local decision or not). If a connection is not protected by the local link, then the connection will be stored in the active connection table, and the connection manager then sends a command to the hardware via the driver object, which is shown as connection 450, 490 onto link T in FIG. 3. However, if a connection is protected by the local link, then this connection is recorded in both the active connection table and the inactive connection table P, with the properly mapped input and output indices. In FIG. 3, connection 50,20 onto link W is protected by connection 50, 220 onto link P. See FIG. 4 for the active connection table and inactive connection table P as an example.

Continuing from the previous example, if the node detects a failure on link W, the node's higher-level application (e.g., link manager) knows that this link W is locally protected by link P. Therefore the application sends a command to the connection manager indicating that all the connections must be switched over to link P. If the node does not support multiple configuration settings, then the switchover is done by modifying each existing connection (tear-down and connect), which obviously involves a sequence of messages for all the connections in the switchover. However, if the switching card does support multiple configuration settings then the connection manager simply activates the connection table P (which becomes active, and the previously active connection table is now inactive), and sends an activate command to the hardware through the driver or BSP object, and the hardware then activates the corresponding configuration setting to make all the protection connections. All the connections are switched over with a single command, which is faster, more efficient and reliable than doing it one connection at a time.

According to the present invention the following advantages are provided as compared to the prior art solutions:

1. a generic approach can be used in any circuit or virtual connection based switch system;

2. fast local protection and recovery is achieved by making bulk connections with a single command, instead of making each connection one by one;

3. a unified architecture facilitates easy hardware (switch card) upgrade: it can handle different kinds of switching fabric cards;

4. flexibility in the architecture and design provide scalability that accommodates different switch size requirements; and

5. an abstraction layer isolates hardware specific information from the switching node software, that means hardware changes can be achieved with minimum software update.

Applicants contemplate that the underlying inventive concept of the present invention is applicable to the following additional applications:

1. traffic end-to-end re-route instead of local link/trunk level protection and recovery;

2. with minimum change, the design and implementation can be used to handle active/ standby for redundancy, or switching load balancing; and

3. the generic architecture can be extended to handle other cards: different line interface cards, and signaling cards, etc.

Although specific embodiments of the invention have been described and illustrated it will be apparent to one skilled in the art that numerous changes can be made without departing from the basic concept. It is to be understood, however that such changes will fall within the full scope of the invention as defined by the appended claims.

1. A method of managing switch connections at a switching node in a communications system, the method comprising:
providing connection requests from a higher level application to a connection manager in said switching node;
processing said requests in said connection manager and generating a connection table therefrom; and
based on said connection table, routing said commands from said connection manager to switch card elements in said switching nodes to carry out said requests.

2. The method according to claim 1 wherein said commands are routed from said connection manager to said switch card elements through an abstraction layer in said connection manager.

3. The method according to claim 2 wherein said connection table is generated from switch card related information stored in registers in switching card fabric software.

4. The method according to claim 1 wherein said connection requests include connection related commands.

5. The method according to claim 4 wherein said connection related commands include: call set-up; call teardown; modify; inquiry, and connection maintenance such as loopback tests.

6. The method according to claim 1 wherein said connection requests include configuration related requests.

7. The method according to claim 1 wherein said connection table includes input and output port information.

8. The method according to claim 1 wherein said switch card elements support multiple configuration tables.

9. A system for managing switch connections at a switching node in a communications network, said system comprising:
means for receiving connection specific requests from a higher level application;
a connection manager for processing said connection specific requests and generating a connection table which maps external ports to an internal switching matrix for use in routing said requests; and
switch card elements for receiving routing information and carrying out connection requests.

10. The system as defined in claim 9 wherein said connection manager has an abstraction layer to provide an interface to said switch card elements.

11. The system as defined in claim 9 wherein said switch card elements are card specific drivers.

12. The system as defined in claim 9 wherein said connection tables include card related information downloaded from switch fabric card on system initialization.
